(19) United States
(12) Patent Application Publication
(10) Pub. No.: US 2026/0295980 A1
(43) Pub. Date: Oct. 1, 2026

(54) LAMINATE PANEL AND METHOD FOR MANUFACTURING A LAMINATE PANEL

(71) Applicant: ALADDIN MANUFACTURING CORPORATION, Calhoun, GA (US)

(72) Inventors: Peter PROVOOST, Calhoun, GA (US); Jake SNEAD, Calhoun, GA (US)

(21) Appl. No.: 19/480,519

(22) PCT Filed: Apr. 29, 2024
(86) PCT No.: PCT/IB2024/054137

§ 371 Date: Oct. 31, 2025

Related U.S. Application Data
(60) Provisional application No. 63/500,271, filed on May 5, 2023.

(51) Int. Cl. B32B 21/08; B32B 21/02; B32B 37/00; B32B 37/10; B32B 37/16

(52) U.S. Cl. CPC B32B 21/08; B32B 21/02; B32B 37/0046; B32B 37/10; B32B 37/16; B32B 2250/03; B32B 2262/065; B32B 2262/067; B32B 2307/72; B32B 2398/10; B32B 2471/00; B32B 2607/00

(57) ABSTRACT

A laminate panel and a method to produce a laminate panel, includes the steps of: forming a stack; pressing the stack using a pressing device, the pressing device comprising a first press element and a second press element; wherein the second press element comprises an upper surface which faces and contacts the stack, wherein the upper surface comprises a structure, the structure having a base surface and indentations which form lower areas relative to the base surface, wherein maximum height differences between the lower areas and the base surface are at least 100 μm.

This invention relates to a laminate panel, comprising, seen from the top to the bottom, a top layer comprising synthetic material, a substrate, for example a wood fiber board substrate or a particle board substrate, and a balancing layer comprising synthetic material. This invention also relates to a method for manufacturing said panel. The panel can be a floor panel, but can also be another type of panel, such as a furniture panel or a wall panel.

In particular, this invention relates to laminate panels of the following build-up: a top layer comprising at least a wear layer and/or a décor layer, said wear layer being a resin impregnated transparent or translucent paper and said décor layer being a resin impregnated printed paper. The balancing layer is a resin impregnated paper, for example a resin impregnated kraft paper, or comprises resin and is free of sheets. The resin is preferably a thermosetting resin, such as a melamine based resin, a phenol based resin or a urea based resin. Said laminate floor panels are typically obtained by a pressing treatment, for example these laminate panels are direct pressure laminate (DPL), wherein the wear layer, the décor layer, the substrate and the balancing layer are all placed on top of each other, and form a stack, and are all pressed at once. In one and the same pressing treatment the resin is then cured and binds the several layers, including the substrate, to each other. The substrate is preferably a MDF board or a HDF board (Medium Density Fiberboard or High Density Fiberboard) if the panels are floor panels. For furniture panels and wall panels, the substrate can also be particle board.

A disadvantage of said pressing treatment is that potential height of said laminate panel is lost. This because some resin will penetrate the substrate and especially because said substrate is slightly compressed. This means that the height of the laminate panel will always be lower than the height of the stack used to form this laminate floor panel. A thinner laminate panel can be perceived as less qualitative. Of course one can solve this by using a thicker substrate, but this implies that you need more material.

It is therefore an object of the invention to have a method for manufacturing laminate panels, which causes less height loss and/or to have laminate panels with a higher thickness in relation to the amount of material needed.

The object is achieved, according to a first aspect, by providing a method to produce a laminate panel, for example a laminate floor panel, comprising the steps of:
forming a stack comprising a board, a base top layer and a base balancing layer, wherein said board is located between said base top layer and said base balancing layer, wherein said board is preferably a lignocellulose based board such as a wood fiber board or a particle board, and wherein said base top layer comprises synthetic material and said base balancing layer comprises synthetic material;
pressing the stack using a pressing device, said pressing device comprising at least a first press element and at least a second press element, wherein the stack is pressed between said first and second press element in such a way that the first press element contacts the base top layer, the second press element contacts the base balancing layer, the base top layer adheres to the board, the base balancing layer adheres to the board and a pressed stack with the base top layer, the board and the base balancing layer interconnected, is formed;
optionally further processing this pressed stack to form said floor panels;
wherein the second press element comprises an upper surface which faces and contacts the base balancing layer, wherein said upper surface comprises a structure, said structure having a base surface and indentations, which form lower areas relative to said base surface, wherein maximum height differences between said lower areas and the base surface are at least 100 μm, are preferably located between 100 μm and 350 μm, more preferably between 150 μm and 250 μm, most preferably between 180 μm and 220 μm.

Said structure of the upper surface can be indicated with the term ‘microstructure’.

The board can be a lignocellulose based board such as a wood fiber board or a particle board. The result is then for example a wood laminate (floor) panel. The board can also comprise thermoplastic material and optionally fillers and/or optionally plasticizers, and can thus be for example a rigid thermoplastic board or a flexible thermoplastic board. The result is then for example a SPC (stone plastic composite) floor panel or a LVT (luxury vinyl tile) floor panel. More specifically a melamine SPC floor panel or melamine LVT floor panel can be produced. The board can also be a mineral based board, for example an MgO board or a fiber cement board or a gypsum board.

Preferably, in the stack, the board is located between said base top layer and said base balancing layer in such a way, that a first surface of the board faces said base top layer and a second surface of the board, which is opposite said first surface of the board, faces said base balancing layer.

Preferably the press elements are, and more in particular the second press element is, selected from the list of: press plates, press belts, press rollers/calendaring rollers, or press plates with release foils—wherein the said release foil then preferably is a structured release foil which comprises said upper surface—. If the second press element is a press plate, then said press plate comprises said upper surface. Preferably said press plate extends according to a plane and the maximum height differences between said lower areas and the base surface are measured according to a direction perpendicular to the plane of the second press plate. The press plate can be one large plate or can be a combination of two or more smaller plates which are preferably interconnected to each other such that they extend next to each other in the same plane. If the second press element is a press roller, the said base surface preferably extends according to a cylindrically shaped surface and the height differenced are measured according to directions perpendicular to the tangent plane of said cylindrically shaped surface.

The maximum height differences between each lower area and the base surface are preferably identical, meaning that the maximum height difference between each lower area and the base surface is substantially the same. However different height differences are possible.

Preferably the pressing device is a discontinuous pressing device, such as a short cycle press/single daylight press/Kurztaktpresse or a multi daylight press. Pressing is thus preferably done by means of an opening and closing press. With said pressing devices, the synthetic material can well flow into the indentations during pressing, such that the structure of the upper surface of the second press element can be well copied in the base balancing layer.

Prior art press plates which are used to contact the base balancing layer during the press treatment normally have flat upper surfaces. With the aid of said prior art press plates, pressure is distributed evenly upon the stack, ensuring good curing of the balancing layer. Surprisingly is has been found that by providing a press element having said indentations of said height, the pressed stack, meaning the stack after the pressing treatment, has a higher thickness than if a prior art press element would have been used. Further it has been found that possible negative effects upon the curing of the base balancing layer and/or upon the bond between the base balancing layer and the board, can be avoided if said mentioned maximum height difference are between 100 μm and 350 um, preferably between 150 μm and 250 μm, more preferably between 180 μm and 220 μm, and for example 200 μm. The height of a laminate panel can be measured with the aid of a thickness gauge and/or micrometer and/or caliper gauge, for example a dial thickness gauge-a dial thickness gauge of the type FD50-. The micrometer can have flat and parallel circular measuring surfaces of for example 6.34 mm or at least 16 mm diameter, and an accuracy of for example 0.01 mm. Use can be made by thickness measurements methods described in EN13329. Said laminate panel will have protrusions that will match said indentations, and the final height is determined/measured at the height of said protrusions.

Said base top layer and said base balancing layer are preferably attached to said board in such a way that said respective synthetic material has partially penetrated said board. In general, it is preferred that the synthetic material of the base balancing layer penetrates at least partially into the board. Preferably, the board of the pressed stack has at its underside a layer of at least 0.1 mm and still better at least 0.5 mm over which this synthetic material has penetrated into the board.

The obtained pressed stack comprises said base top layer, the board, and the base balancing layer. Said pressed stack is or is not further processed to form said panels, wherein a said panel then comprises a top layer derived from said base top layer, a substrate derived from said board and a balancing layer derived from said base balancing layer.

Furter, if said further processing steps are present, said pressed stack is very suitable to perform said further processing steps upon it, to form for example floor panels, wall panels or furniture panels. Said further processing steps can include dividing the pressed stack into smaller panels and/or providing coupling parts, for example by milling, to form panels with coupling parts. The obtained pressed stack has a base balancing layer comprising protrusions which match said indentations. However, when said indentations are at most 350 μm, preferably at most 250 μm, more preferably at most 220 μm, these protrusions do not negatively influence or barely influence said further processing steps. If said panel comprises coupling parts comprising a tongue and groove, with said groove being bordered by an upper lip and a lower lip, the said balancing layer, at the height of the coupling parts, is then present at the lower lip and forms the bottom of said lower lip, meaning that, if said protrusions are also present at the height of the bottom lip, said protrusions do not hinder the forming of said coupling parts. Further, milling is mostly done upside down, such that the protrusions do not affect panel alignment. Preferably the entire upper surface of the press plate comprises said indentations, such that also at the height of the grooves of the coupling parts, said indentations are present. However it is also possible that only parts of the upper surface have said indentations, such that, for example no protrusions are present at the height where the coupling parts are made.

With the aid of the method, said panels can be easier installed upon a surface. For example if the panels are floor panels which are connected to each other with the aid of coupling parts, said protrusions reduce the friction between the panels and the surface upon which the panels need to be laid, such that shifting movements which are made during installation, will be less hindered. Also dust and small objects, such as pebbles, can get trapped between said protrusions and as such not negatively influence installation and/or not cause premature wear. Also during production said protrusions have benefits. Panels comprising said protrusions can be transported with less friction and can be stacked on top of each other more easily. Surprisingly sound properties also improve. Surprisingly it was also found that if the first press element is a structured press element which forms embossments in the base top layer, less pressing defects occur at the height of the base top layer. This is especially the case for base top layers with deep embossments with thicknesses of more than 0.15 mm or more than 0.3 millimeter.

Preferably further processing steps are performed upon the pressed stack to form said panels. Of course, said pressed stack could already form the panel as such. However preferably, for economic reasons and ease of production, said pressed stack has such dimensions that it forms a big panel from which various panels are obtained. Said further processing step are then preferably dividing steps, such as sawing steps, to divide said big panel into smaller panels. Optionally said processing steps also comprise providing said smaller panels with coupling parts, and this for example by milling.

If coupling parts are present, said panels can be coupled to each other by turning movements, shifting movements, downward movements, etc. and this depending on the type of coupling parts. Surprisingly, it has been found that coupling parts can be well formed in said pressed stack and this without compromising upon the coupling strength.

The floor panels are preferably rectangular shaped, elongate or square, and comprise a first pair of opposite edges with coupling parts and a second pair of opposite edges with coupling parts. The said coupling parts are preferably in the form of a tongue at one edge of the first pair of opposite edges and a groove at the other edge of the first pair of opposite edges, and wherein more preferably the groove is bordered by an upper lip and a lower lip, wherein said lower lip could distally extends beyond the upper lip. The coupling parts of the second pair of opposite edges can have a similar configuration as the coupling parts of the first pair of opposite edges or the second pair of opposite edges can have a male coupling part and a female coupling part comprising respectively a downward directed upper hook-shaped portion and an upward directed lower hook-shaped portion. The lower hook-shaped portion could comprise a lip with an upward directed locking element that defines, proximally thereto, a female part in the form of a recess, while the upper hook-shaped portion comprises a lip with a downward directed locking element that forms a male part. These coupling parts could be connected to each other by a downward movement. Preferably the coupling parts of the first pair of opposite edges are then preferably couplable to each other by a turning movement, such that during the turning movement, also coupling parts of the second pair of opposite edges are coupled to each other.

These laminate panels are preferably floor panels and can be selected from the list:
decorative particle boards, comprising from top to bottom a decorative top layer comprising at least one resin impregnated paper, a particle board, and a (decorative) balancing layer comprising for example a resin impregnated kraft paper. The resin is preferably a melamine comprising resin (melamine faced particle board), such as a melamine formaldehyde resin. Instead of a melamine resin, other thermosetting resins can be used such as phenol based resins or urea based resins or acrylate based resins;
a wood laminate floor panel, comprising from top to bottom a decorative top layer comprising one or more resin impregnated papers, a wood fiber board (e.g. HDF), and a balancing layer comprising for example a resin impregnated paper. The resins are preferably thermosetting resins;
a mineral based panel, comprising from top to bottom a decorative top layer, a mineral based board (for example a board comprising MgO or cement or gypsum) and a balancing layer.
melamine SPC, comprising a decorative top layer comprising from top to bottom a top layer comprising one or more resin impregnated paper layers, a core comprising thermoplastic material, and a balancing layer comprising a thermosetting resin. The resin is preferably a melamine comprising resin, such as a melamine formaldehyde resin. Instead of a melamine resin, other thermosetting resins can be used such as phenol based resins or urea based resins or acrylate based resins.
a panel comprising from top to bottom a top layer comprising one or more resin impregnated paper layers, a board comprising recycled material, such as shredded rigid PIR/PUR (polyisocyanurate/polyurethane), and a balancing layer.

Preferably said laminate panels are of the so-called DPL type.

The dimensions of the indentations are such that the maximum height differences between said lower areas and the base surface are higher than 100 μm, preferably higher than 150 μm, more preferably higher than 180 μm, most preferably higher than 190 μm. Also preferably said maximum height differences are lower than 350 μm, preferably lower than 250 μm, more preferably lower than 220 μm, most preferably lower than 210 μm. For example said maximum height differences between said lower areas and the base surface can be 198 μm, 199 μm, 200 μm, 201 μm or 202 μm. These dimensions gave the best results. Greater height differences could lead to pressing defects and unwanted deformations of the substrate, lower height differences do not cause the desired benefits, thus still result in unwanted height losses when forming the floor panel.

Preferably, the synthetic material of the base top layer and/or the base balancing layer, is a thermosetting synthetic material, such as a thermosetting resin. However this does not mean that the synthetic material in the base top layer and the base balancing layer needs to be the same or similar, of course this can be the case. Possible thermosetting resins are melamine based resins such as melamine resins, melamine urea formaldehyde resins or melamine formaldehyde resins—, acrylic based resins—such as an acrylate resin—, urea based resin—such as urea formaldehyde resins—, phenol based resin—such as a phenol formaldehyde resin—, polyester based resins, or polyurethane based resins. These thermosetting resins could comprise additives, such as plasticizers, liquefiers, solvents, solidifiers, filling material, anti-foaming agents, antistatic agents—such as a salt solution—, conductive materials, curing agents or catalysts. Of course, it is not excluded to apply a thermoplastic resin. It is also not excluded to work with a blend of resins, such as a blend of melamine formaldehyde resin and urea formaldehyde resin, and/or to apply a different synthetic material in the base top layer than in the base balancing layer.

The base top layer and/or the base balancing layer can comprise resin impregnated papers, wherein said papers can have a dry paper weight of between 50 to 150 g/m². Said base balancing layer could only comprise said synthetic material, for example only comprise a thermosetting resin, or could comprise a resin impregnated paper. The base top layer can for example comprise a resin impregnated printed paper, a so-called décor layer. This paper can be a digitally or analogously printed paper. This paper preferably has a weight between 60 and 150 grams per square meter, wherein to obtain floor panels, the weight may be limited to 100 grams per square meter. The heavier papers may be used, for example, in furniture panels. The base top layer can further comprise a resin impregnated transparent paper which forms a so-called wear layer or overlay. This transparent paper preferably has a weight between 15 and 40 grams per square meter, wherein with a paper of approximately 25 grams per square meter, an optimum is achieved between the strength of the paper and the possibly obtainable transparency thereof. The wear layer can comprise wear resistant particles, such as corundum. The base top layer can optionally comprise additional resin impregnated papers, for example resin impregnated kraft papers which can be located between the board and the decor layer for additional strength and impact resistance.

Preferably, the ratio between the total weight of synthetic material in the base top layer to the total amount of paper in this base top layer is situated between 150% and 350% and still better between 200% and 300%.

In a preferred embodiment the pressing device is a discontinuous pressing device and the first and second pressing element comprise press plates, preferably are a first press plate and a second press plate. These press plates are preferably metal press plates. Pressing with a discontinuous pressing device with press plates, ensures that the synthetic material, during the pressing can flow well and fill up the indentations in a good manner, as such resulting in a pressed stack with protrusions that well resemble said indentations. Here the said upper limit of the maximum height differences is of importance, since the higher the maximum height differences, the more time is needed for the synthetic material to fill up the entire spaces of said indentations and this during pressing. If the synthetic material is a thermosetting resin that hardens out during pressing, it is important that the indentations are filled up well with the resin before curing starts or before the final curing. Said stack can be formed in said pressing device, when the press plates are at a certain distance from each other or the stack can be formed outside said pressing device and then placed between said press plates. Preferably said press plates and said stack are positioned with regard to each other in such a way that the base surface is substantially parallel to the board. Optionally use can be made of said structured foil between the stack and the second press plate.

Said balancing layer of the panel can completely form the bottom of the panel. However other embodiments are also possible. For example at least the space surrounding said protrusions according to the plane of the panel can be filled up with filling material and this preferably at least over the entire height of the protrusions. The filling material can be a foam-such as a polyurethane foam, a polystyrene foam, an ethylene vinyl acetate foam, irradiation cross-linked polyethylene-. Said filling material is preferably applied to the base balancing layer of the pressed stack, thus after pressing, and this more preferably in a controlled manner such that a panel with a flat bottom can be obtained. Said filling material can improve some features of the panel, for example can have a positive effect upon the sound and/or walking comfort. This filling material can form a pad attached which completely surround the protrusions. Here less filling material is needed to provide the panel with the desired benefits. Said filling material is applied after the pressing of said stack. In a specific embodiment said filling material can be applied in such a way that it protrudes beyond the protrusions of the panel according to the height direction, in such a way that it forms a bottom surface of the panel or a surface of the panel which lies below said protrusions. In another embodiment, said filling material can be applied in such a way that it does not protrude beyond the protrusions, and preferably the protrusions and the filling material together form the bottom of the panel. It is also possible to attach another layer to the base balancing layer of the pressed stack, in the form of a pad attached, wherein said panel then comprises a separate pad attached to the protrusions, wherein said separate pad forms the bottom and which does not surround the protrusions. This pad attached can be or cannot be a foamed layer comprising for example polyurethane, polystyrene, ethylene vinyl acetate, polyethylene-for example irradiation cross-linked polyethylene-.

In a very preferred embodiment, the indentations are individual indentations separated by said base surface, said base surface forming partitions between said indentations, wherein said partitions substantially form a continuous whole. This means that each indentation is a separate indentation, which does not directly contact another indentation. Because said base surface forms one continuous whole, pressure is well and evenly distributed upon the balancing layer, as a result that said synthetic material can flow well in all the indentations and overcuring is avoided. The formed pressed stack and thus the resulting panel will have individual protrusions, which have many benefits, for example, dust and pebbles can easily be removed from between said individual protrusions, such panels show lower friction rates and can thus be more easily installed upon a surface and can be easily stacked, or for example the above-mentioned filling material can be well applied to said base balancing layer. Said indentations can have several shapes and dimensions, preferably substantially all the indentations have the same shape and dimensions. For example said indentations can have sections parallel to the base surface which, at least at the height of the lower areas, are selected form the following list: circles, squares, triangles, hexagons, octagons, rhombuses.

Further preferably the indentations are separated from each other at equal distances from each other. The result is a base surface that is very capable of spreading pressure equally upon the balancing layer during pressing. More preferably also the indentations have the same dimensions, such that parts of the balancing layer, irrespective of their positions, all experience similar pressing forces.

Maximum distances between two subsequent protrusions are preferably between 0.5 mm and 3 mm, preferably between 1 mm and 2.5 mm. The base surface has a sufficiently large enough surface to spread the pressure equally over the base balancing layer and this without compromising too much upon the gain in thickness.

In a very preferred embodiment the indentations have the same shape and dimensions. This results in a panel comprising a balancing layer with protrusions having the same shape and dimensions, such that such a panel can placed parallel with regard to a flat surface. Small height differences and dust have less influence upon the correct installation of these panels, then it would have upon panels comprising a completely flat bottom.

In a very preferred embodiment, the base surface and the indentations form a recurring pattern.

Preferably the base surface extends in a first plane, and more preferably this first plane is parallel with the stack.

Also preferably the lower areas are substantially flat and preferably all extend in a second plane. Said lower areas form the bottoms of said indentations and determine said maximum differences in height.

Further preferably said first and second plane are parallel to each other such that a pressed stack is obtained and thus panels are obtained, which, when being placed upon a flat surface, extend parallel to said surface.

Also further preferably, the indentations have curved or flat slopes which separate the lower areas from the base surface, said slopes preferably having an inclination with the lower areas between 90° and 135°. Said slopes can form smooth transitions between the base surface and corresponding lower areas, but can also have transitions with corners. Said slopes ensures that the second press element can easily come loose from the pressed stack after the pressing is done.

Also preferably, seen according to the plane of the press element, the lower areas have a first circumscribed circle and the corresponding surrounding partitions of the base surface have a second circumscribed circle with the same center as the first circumscribed circle, wherein the ratio of the radius of the first circumscribed circle upon the radius of the second circumscribed circle, is located between 0.5 and 0.9, preferably between 0.6 and 0.85, for example 2/3 or 1/6. It has been found that with these dimensions the best results are obtained. For example the first circumscribed circle can have a radius of 2 mm and the second circumscribed circle can have a radius of 3 mm, or the first circumscribed circle can have a radius of 2.25 mm and the second circumscribed circle can have a radius of 3 mm, or the first circumscribed circle can have a radius of 2.5 mm and the second circumscribed circle can have a radius of 3 mm. For example the radius of the first circumscribed circle can be between 1.5 and 2.5 mm and the radius of the second circumscribed circle can be between 2.5 and 4 mm.

The lower areas are preferably polygon shaped, more preferably regular polygon shaped. Further preferably said polygon shaped lower areas are flat and more preferably all extend in the same plane—or at least in parallel extending planes—.

The lower areas are for example hexagon or octagon shaped, preferably regular hexagon or octagon shaped. Most preferably the lower areas are hexagon shaped, e.g. regular hexagon shaped.

The pressing can take place at a maximum temperature of between 180° C. and 220° C., for example the maximum temperature can be approximately 200° C.

The pressing can take place at a maximum pressure of at most 60 bar, for example at a maximum pressure of approximately 45 bar.

The pressing can take place between 10 and 40 seconds, for example can be between 18 and 22 seconds. Since the press treatment takes place for at least 10 seconds, said indentations can be filled up well with the synthetic material during pressing.

For example the pressing can be done in a discontinuous press using a temperature of at least 150° C. for example between 180° C. and 220° C. or between 150° C. and 200° C., and a duration of the pressing between 12 to 60 seconds, and a pressure of more than 20 bar, e.g. between 35 and 40 bar or between 20 to 80 bar.

In a very preferred embodiment the board has an average density of at least 600 kg/m³ and/or of at most 1000 kg/m³, and wherein more preferably the board is a lignocellulose based board, for example a wood fiber board. Said average densities ensure that said indentations get filled up well during pressing and the risk of pressing defects are low. With average density is indicated that said densities do not have to be the same at all the locations of said board, for example do not have to be the same over the entire thickness. For example, more centrally the density can be lower than the average density and at the height of the outer surfaces of the board, the density can be higher than the average density. For example the board can comprise MDF or HDF material with an average density of between 600 and 800 kg per cubic meter and with higher density regions at least at the height of said outer surfaces, wherein said higher density regions have a density of at least 800 kilograms per cubic meter, or at least 850 kilograms per cubic meter, or at least 900 kilograms per cubic meter or more. Said higher density region at the height of said outer surface facing the base balancing layer, together with a less dense more centrally located region, ensures good distribution of said synthetic material in said indentations during pressing.

In a very preferred embodiment the thickness of the pressed stack is at most 0.3 mm thinner than the thickness of the stack before the pressing, preferably at most 0.25 mm. This thickness can be measured with the aid of a micrometer, a caliper gauge or a thickness gauge, for example a dial thickness gauge—a dial thickness gauge of the type FD50—. Use can be made of other thickness measurement methods as described earlier in the description. The thickness of the laminate panel is measured from the top surface to the bottom of the protrusions. The board, before pressing can have a thickness of between 4 and 15 mm, preferably between 7 and 12 mm, more preferably between 8 and 11 mm. For example the board can be 8 or 8.5 or 9 or 9.5 or 10 mm HDF/MDF. For example, if the board is 10 mm HDF/MDF board, the final thickness of the pressed stack is preferably more than 9.8 mm.

In a very preferred embodiment the thickness of the pressed stack is at most 3% thinner in comparison to the thickness of the stack before the pressing, preferably at most 2.5%.

In a very preferred embodiment said synthetic material of the base top layer and/or the base balancing layer is a thermosetting resin. Most preferably at least the synthetic material of the base balancing layer is a thermosetting resin. This thermosetting resin can a melamine resin, an acrylic resin, a urea formaldehyde resin, a melamine urea formaldehyde resin, a urea resin, a melamine formaldehyde resin, a polyester resin, a phenol formaldehyde resin or a polyurethane resin. The synthetic material of the base top layer can or cannot be identical to the synthetic material of the base balancing layer. If the base balancing layer comprises a thermosetting resin, said thermosetting resin can be a filled thermosetting resin, meaning a thermosetting resin comprising filling material, such as chalk, limestone, talc or heat expandable material—e.g. polystyrene—. Said thermosetting resin can or cannot comprise additives, for example additives to improve the flow properties of the resin and/or curing properties.

Further, in a specific embodiment, both synthetic materials of the base top layer and the base balancing layer are thermosetting resins, wherein the base top layer comprises a first thermosetting resin and the base balancing layer comprise a second thermosetting resin, wherein said first thermosetting resin differs from said second thermosetting resin, wherein preferably said second thermosetting resin is less reactive than said first thermosetting resin. The first and the second thermosetting resin can then be adapted in a good manner. For example the second thermosetting resin is less reactive than said first thermosetting resin, indicating that during pressing, the first thermosetting resin will cure in a faster manner then the second thermosetting resin, such that the second thermosetting resin has more time to fill up the indentations during pressing, such that the pressed stack has protrusions which match the indentations. Said first and second thermosetting resins can differ by one or more of the following characteristics: the type of resin—for example melamine resin, an acrylic resin, a urea formaldehyde resin, a melamine urea formaldehyde resin, a urea resin, a polyester resin, a melamine formaldehyde resin, a phenol formaldehyde resin or a polyurethane resin—, catalysts, additives, filling material, etc.

In a very specific embodiment the laminate panel comprises a first pair of opposite edges and a second pair of opposite edges, wherein said further processing steps at least comprise providing coupling parts to form a laminate panel with a first pair of opposite edges provided with coupling parts, wherein said coupling parts are preferably in the form of a tongue at one edge of the first pair of opposite edges and a groove at the other edge of the first pair of opposite edges, and wherein more preferably the groove is bordered by an upper lip and a lower lip, wherein said lower lip distally extends beyond the upper lip and the lower lip comprises said protrusions.

Preferably, with said tongue and groove, two such floor panels are couplable to each other by a turning movement and/or horizontal shifting movement. Said lower lip can comprise said protrusions, meaning that the base balancing layer can obtain by pressing, over a large portion of its surface and irrespective of the panels which are manufactured from said pressed stack, protrusions, meaning that height increase can be maximized. Further this indicates that irrespective of the dimensions of the panels obtained from said pressed stack, the second press element can be the same. The first press element can be changed according to the design and/or dimensions of the floor panels, and this while only one second press element is used. However, embodiments where no protrusions are present at the height of said lower lips, are also possible. For this the upper surface of the second press element is then designed according to the dimensions of the floor panels to be obtained.

Further preferably said panel comprises a second pair of opposite edges with a male and a female coupling part, wherein the male coupling part and the female coupling part of the second pair of opposite edges can comprise a downward directed upper hook-shaped portion and an upward directed lower hook-shaped portion. The lower hook-shaped portion could comprise a lip with an upward directed locking element that defines, proximally thereto, a female part in the form of a recess, while the upper hook-shaped portion comprises a lip with a downward directed locking element that forms a male part. These coupling parts could be connected to each other by a downward movement. Preferably the coupling parts of the first pair of opposite edges are then preferably couplable to each other by a turning movement, such that in the same turning movement, also coupling parts of the second pair of opposite edges are coupled to each other.

Preferably, at least the synthetic material of the base balancing layer comprises additives which increase the flow and/or flexibility of the synthetic material, such that the synthetic material is very well adapted to take up the shape of the upper surface of the second press element. The synthetic material could for example have one or more of the following features:
the synthetic material comprises diethylene glycol to improve the flow properties;
the synthetic material comprises dicyandiamide, for example the synthetic material can be a melamine-formaldehyde resin comprising dicyandiamide, wherein said dicyandiamide is preferably present in an amount suitable for increasing flexibility and stretchability of said melamine-formaldehyde resin during pressing and curing in a direct-pressure laminate process. For example the melamine-formaldehyde resin, which comprises dicyandiamide, comprises formaldehyde and melamine in a formaldehyde/melamine molar ratio within the range of from 1.60 to 1.80, preferably from 1.70 to 1.80, more preferably from 1.73 to 1.75. Preferably dicyandiamide is present in an amount within the range of from 25 to 45%, more preferably from 30 to 40%, even more preferably from 32% to 38%, and most preferably from 34 to 36%, by weight based on the total weight of melamine and dicyandiamide. Said melamine-formaldehyde resin can comprise a polyol, most preferably glycerol, in an amount within the range from 1 to 5%, preferably from 2 to 4%, more preferably from 3 to 4%, by weight based on the total liquid weight of the resin.

The synthetic material of the base top layer could also comprise the abovementioned features.

In a preferred embodiment, at least the synthetic material of the base balancing layer, comprises one or more catalysts chosen from the list:
a pressure activatable catalyst;
an encapsulated catalyst;
an organic carboxylic acid, preferably heptanoic acid.

The synthetic material of the base top layer could also comprise catalysts.

When a catalyst comprising, or essentially consisting of, a pressure activatable catalyst is used, the curing of synthetic material can be partially, largely or wholly delayed until pressure is applied during pressing. So doing, the risk that pressing defects will occur is minimized.

When a catalyst comprising, or essentially consisting of, an encapsulated catalyst is used, the shell of the capsule may keep the catalyst from prematurely activating curing. The release may for example be delayed until the shell disintegrates due to heat and/or pressure.

Preferably, at least two of the above properties are combined. For example, the encapsulated catalyst is a carboxylic acid.

According to a first deviating variant of this first aspect, the invention relates to a method to produce a laminate panel, for example a laminate floor panel, comprising the steps of:
forming a stack comprising a board and a base top layer, wherein said board is preferably a thermoplastic based board, wherein said base top layer comprises synthetic material and preferably comprises one or more thermoplastic sheets;
pressing the stack using a pressing device, said pressing device comprising at least a first press element and at least a second press element, wherein the stack is pressed between said first and second press element in such a way that the first press element contacts the base top layer, the second press element contacts the board, the base top layer adheres to the board and a pressed stack with the base top layer and the board interconnected, is formed;
optionally performing further processing steps upon this pressed stack to form said floor panels;
wherein the second press element comprises an upper surface which faces and contacts the board, wherein said upper surface comprises a structure, said structure having a base surface and indentations which form lower areas relative to said base surface, wherein maximum height differences between said lower areas and the base surface are at least 100 μm, and are preferably are located between 100 μm and 350 μm, more preferably are located between 150 μm and 250 μm, most preferably are located between 180 μm and 220 μm.

With a thermoplastic based board is indicated a board comprising thermoplastic material as a binder material and comprising optionally fillers—such as inorganic fillers (for example chalk or limestone or talc) or organic fillers (for example wood fibers)—and/or optionally plasticizers. With thermoplastic sheets can for example be indicated printed thermoplastic sheets or thermoplastic sheets functioning as wear layer. For example the base top layer can comprise a thermoplastic sheet which functions as wear layer and a printed plastic sheet which functions as a décor layer. With the aid off such a pressed stack, SPC floor panels (stone plastic composite) or a LVT floor panels (luxury vinyl tile) or a WPC floor panels (waterproof plastic composite) can be obtained. The pressing for such panels is typically done with the aid of calendaring rolls in a continuous pressing treatment. The second press element is thus preferably a calendaring roll with said specific structure. All the benefits and embodiments described for the method according to the first aspect of the invention also apply mutatis mutandis for this first deviating variant, with of course the difference that no base balancing layer is present and the said protrusions of the pressed stack and the obtained panel are therefore present in the board material, thus is in the substrate of the floor panel.

According to a second deviating variant of the first aspect of the present invention, the base balancing layer and/or the base top layer comprises, instead of synthetic material, a natural resin or a blend of a natural resin and synthetic material, or a bio-based resin. The natural resin can for example be lignosulphonate. The bio-based resin can be a bio-based glue. All the benefits and embodiments described for the method according to the first aspect of the invention also apply mutatis mutandis for this second deviating variant. Thus the invention also relates to a method to produce a laminate panel wherein said base top layer comprises a thermosetting resin, this thermosetting resin being or not being a synthetic material, and said base balancing layer comprises a thermosetting resin, this thermosetting resin being or not being a synthetic material.

This invention, according to a second aspect, relates to a laminate panel, comprising, seen from the top to the bottom, a top layer comprising synthetic material, a substrate, for example a lignocellulose based substrate such as a wood fiber board substrate or a particle board substrate, and a balancing layer comprising synthetic material, wherein the balancing layer comprises an outer surface opposite said substrate, said outer surface comprising a structure having a base bottom surface and individual protrusions which protrude with regard to said base bottom surface, wherein maximum differences in height between said base bottom surface and said protrusions are at least 100 μm, are preferably between 100 μm and 350 μm, more preferably between 150 μm and 250 μm, most preferably between 180 μm and 220 μm. Said structure can be indicated with the term ‘microstructure’.

Such a laminate panel can be obtained by the method of the invention according to the first aspect. All the benefits and embodiments described above, therefore also apply mutatis mutandis for this laminate panel of the invention. Of course this laminate panel could also be obtained by other methods. Preferably said top layer and said balancing layer are attached to said substrate in such a way that said respective synthetic material partially has penetrated said substrate. The said balancing layer can form the bottom of the panel, this entirely or at least partially. Optionally, said panel can have additional material at the height of the bottom of the panel. For example the panel can have a pad attached, which is glued upon the balancing layer. This pad attached can for example comprise a (thermoplastic) foamed material. For example the pad attached can comprise polyvinylchloride, polyethylene terephthalate, polypropylene, polyethylene. The space surrounding the protrusions can also be filled up with filling material and this preferably at least over the entire height of the protrusions, and optionally beyond said protrusions according to the height direction. The filling material can be a (thermoplastic) foamed material as disclosed above.

This laminate panel according to the invention has several benefits with regard to similar laminate panels where the balancing layer has a base bottom surface which is completely flat, e.g. which does not have a structure as described above. Said benefits are among others, that less material is needed to have floor panel with the same height dimensions, said floor panels can be more easy installed upon a surface if said balancing layer at least partially forms the bottom of the panel—and this among others, because said protrusions reduce the friction between the panels and the surface upon which the panels are be laid, or because dust and small objects, such as pebbles, can get trapped between said protrusions and as such not negatively influence installation—, said floor panels can be transported with less friction and can be stacked on top of each other more easily and sound properties are improved. If said laminate panels comprises opposites edges with coupling parts, said protrusions can or cannot be present at the height of at least some of said coupling parts. If protrusions are present at the height of coupling parts, then these protrusions can make said coupling parts more flexibles, as such making the installation easier.

Said protrusions preferably all have the same height and further also preferably all the dimensions of said protrusions are approximately the same. In this way this floor panel can be placed upon a substantially flat surface in such a way that the plane of the floor panel extends parallel to said flat surface. Dust and minor height difference of said substantially flat surface can be easily overcome by said protrusions.

In a preferred embodiment the base bottom surface extends in a first plane which is according to the plane of the floor panel, wherein said base bottom surface forms partitions between said protrusions, wherein said partitions substantially form a continuous whole.

Preferably said protrusions are separated from each other at equal distances from each other, wherein maximum distances between two subsequent protrusions are for example between 0.5 mm and 3 mm, preferably between 1 mm and 2.5 mm.

In a very preferred embodiment the protrusions have the same shape and dimensions.

Also preferably the protrusions comprise a top plane, wherein the top planes preferably all extend in a second plane, and wherein further preferably said first plane and said second plane are parallel to each other. Such a floor panel can be placed parallel upon a flat surface.

The top planes of the protrusions are preferably separated from the base plane by curved or flat slopes, said slopes having an average inclination with the top planes situated between 90° and 135°.

Said top planes can be polygon shaped, preferably regular polygon shaped. The radius of the circumscribed circle of said regular shaped polygon is preferably between 1.75 mm and 3 mm, for example 2 mm or 2.25 mm or 2.5 mm.

The top planes are for example hexagon or octagon shaped, preferably regular hexagon or octagon shaped. Preferably the top planes are hexagon shaped, most preferably regular hexagon shaped.

The substrate can have an average density of at least 600 kg/m³ and/or of at most 1000 kg/m³. In a specific embodiment the substrate is lignocellulose based substrate, such as a wood fiber board substrate or a particle board substrate.

Preferably a said synthetic material of the top layer and/or the balancing layer is a thermosetting resin, wherein preferably the top layer comprises a first thermosetting resin and the balancing layer comprise a second thermosetting resin, wherein said first thermosetting resin does or does not differ from said second thermosetting resin. Possible embodiments of this synthetic material described in the first aspect of the invention also apply to this panel. The synthetic material of the balancing layer can thus be a thermoplastic resin or a thermosetting resin. The synthetic material of the balancing layer can comprise additives, such as plasticizers, liquefiers, solvents, solidifiers, filling material, anti-foaming agents, antistatic agents—such as a salt solution—, conductive materials, curing agents, catalysts, etc.

The substrate can be chosen from the list of: lignocellulose based substrate—for example particle board, MDF or HDF—, resilient substrate comprising thermoplastic material, mineral substrate comprising for example MgO or cement or gypsum, a board comprising glued together PIR/PUR waste.

The top layer and/or the balancing layer preferably comprises one or more papers impregnated by a thermosetting synthetic material. The thermosetting synthetic material can be a melamine based resin or a phenol based resin or a urea based resin or an acrylic based resin.

According to first deviating variant of the second aspect, this invention also relates to a floor panel, comprising, seen from the top to the bottom, a top layer comprising synthetic material, a substrate, for example a thermoplastic based substrate, wherein the substrate comprises an outer surface opposite said top layer, said outer surface comprising a structure having a base bottom surface and individual protrusions which protrude with regard to said base bottom surface, wherein maximum differences in height between said base bottom surface and said protrusions are at least 100 μm, preferably between 100 μm and 350 μm, more preferably between 150 μm and 250 μm, most preferably between 180 μm and 220 μm. Said structure can be indicated with the term ‘microstructure’. All the benefits and embodiments described for the laminate panel according to the second aspect of the invention also apply mutatis mutandis for this deviating variant, with of course the difference that no base balancing layer is present and the said protrusions are therefore present in substrate of the floor panel.

According to a second deviating variant of the second aspect of the present invention, the balancing layer and/or the top layer comprises, instead of synthetic material, a natural resin or a blend of a natural resin and synthetic material, or a bio-based resin. The natural resin can for example be lignosulphonate. The bio-based resin can be a bio-based glue. All the benefits and embodiments described for the second aspect of the invention also apply mutatis mutandis for this second deviating variant. Thus the invention also relates to a laminate panel wherein said top layer comprises a thermosetting resin, this thermosetting resin being or not being a synthetic material, and said balancing layer comprises a thermosetting resin, this thermosetting resin being or not being a synthetic material.

With the intention of better showing the characteristics of the invention, herein below, as an example without any limitative character, some embodiments are described, with reference to the following figures:

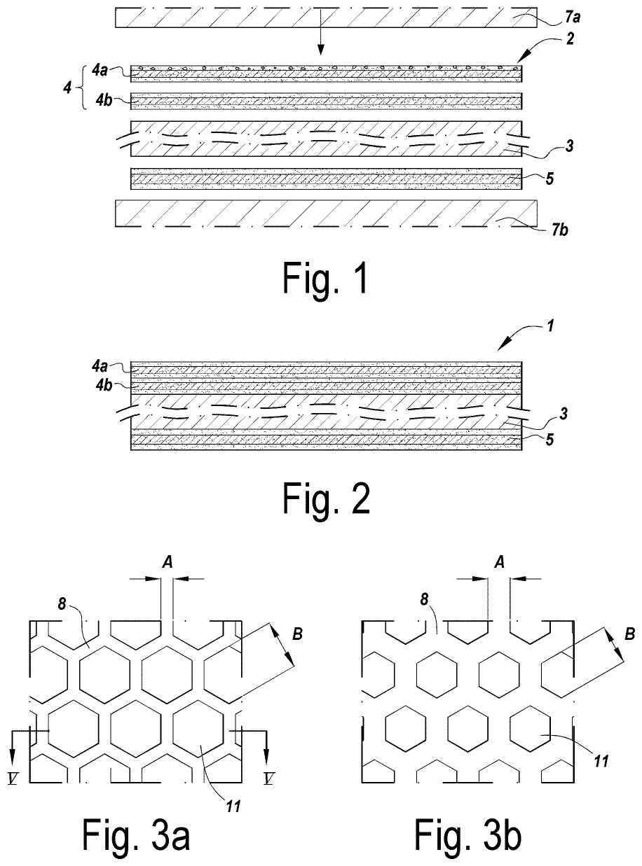

FIG. 1 is a schematic and exploded view of a step of a method to produce a laminate panel according to a first embodiment the invention, wherein a stack is located between a first and a second press plate;

FIG. 2 is a cross section of the pressed stack obtained by pressing the stack shown in FIG. 1 with the first and second press plate;

FIG. 3a is a first possibility of a top view of part of the upper surface of the second press plate according to the first embodiment of the invention;

FIG. 3b is a second possibility of a top view of part of the second press plate according to the first embodiment of the invention;

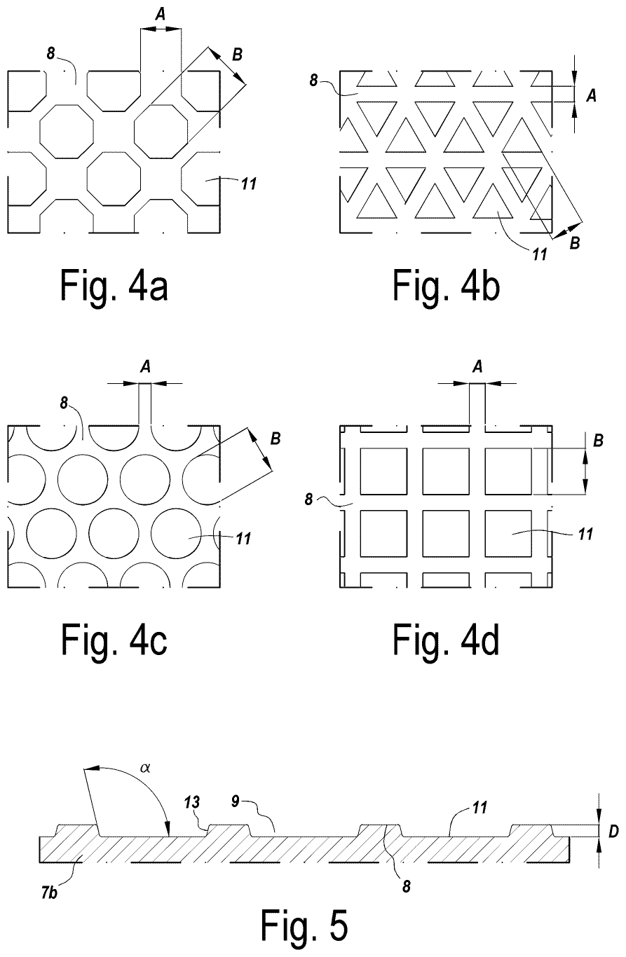

FIG. 4a is a third possibility of a top view of part of the second press plate according to the first embodiment of the invention;

FIG. 4b is a fourth possibility of a top view of part of the second press plate according to the first embodiment of the invention;

FIG. 4c is a fifth possibility of a top view of part of the second press plate according to the first embodiment of the invention;

FIG. 4d is a sixth possibility of a top view of part of the second press plate according to the first embodiment of the invention;

FIG. 5 is a cross section of part of the second press plate according to the first possibility, wherein the structure of the upper surface is visible;

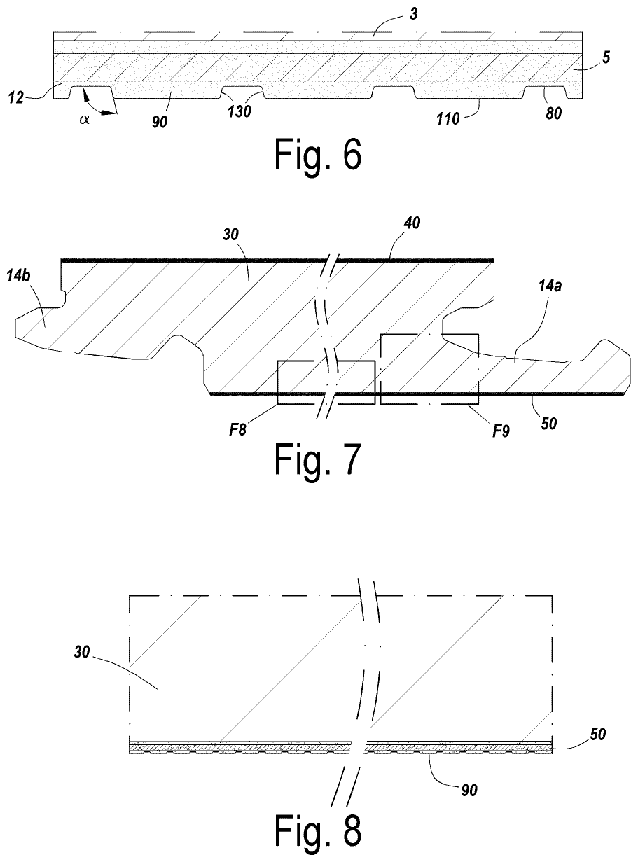

FIG. 6 is a cross section of part of a pressed stack at the height of the base balancing layer, wherein said pressed stack is produced with the aid of the second press plate according to the first possibility;

FIG. 7 is a cross section of a panel according to the invention, wherein the panel comprises a first pair of opposite edges comprising coupling parts;

FIG. 8 is a detailed view of F8 of FIG. 7;

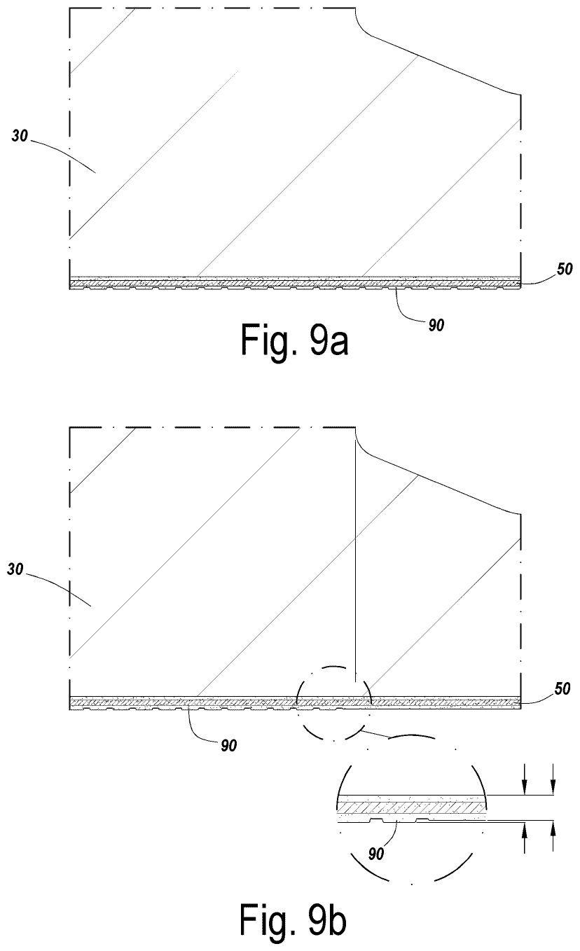

FIGS. 9a and 9b are two possible embodiments of a detailed view of F9 of FIG. 7;

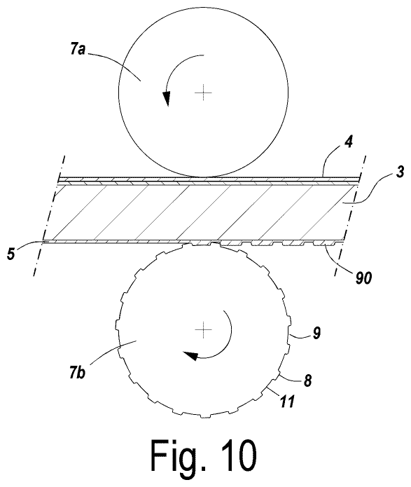

FIG. 10 is a schematic view of a step of a method to produce a laminate panel according to a second embodiment the invention, wherein a stack is being pressed between a first calendaring roll and a second calendaring roll.

The FIGS. 1 to 5 relate a first embodiment of a method to produce a laminate panel 10 according to the invention. FIG. 10 relates to a second embodiment of a method to produce a laminate panel 10 according to the invention. FIGS. 6 to 9 relate to laminate panels 10 according to the invention, which can be produced by said first embodiment or said second embodiment or a not shown embodiment. These panels can be floor panels 10, wall panels or furniture panels. Below we will talk about floor panels 10, however the features discussed below are also possible features for wall panels or furniture panels.

In the first embodiment, the method to produce the laminate floor panel 10 comprises the following steps:
forming a stack 2 comprising, from top to bottom, a base top layer 4, a board 3 and a base balancing layer 5. The base top layer 4 as shown in FIGS. 1 and 2 comprises two resin impregnated sheets 4a, 4b, more specifically two resin impregnated papers 4a, 4b. The resin of the uppermost resin impregnated paper 4a is a thermosetting resin, preferably a melamine based resin, such as a melamine formaldehyde resin, wherein said thermosetting resin comprises hard particles, for example aluminum oxide, titanium carbide, silicon carbide, corundum or silicon oxide. This uppermost resin impregnated paper 4a can also be indicated as the wear layer 4a. The resin of the lowermost resin impregnated paper 4b is a thermosetting resin, preferably a melamine based resin, such as a melamine formaldehyde resin, wherein said thermosetting resin preferably not comprises said hard particles. The paper of the lowermost resin impregnated paper 4b is a printed paper, for example a digitally printed or analogously printed paper. This lowermost resin impregnated paper 4b can be indicated as the décor layer 4b. The board 3 can be a wood based board, for example an MDF or HDF. The average density of said wood based board is preferably between 600 and 1000 kg/m³. The base balancing layer 5 is a resin impregnated sheet, preferably a resin impregnated paper sheet, wherein said resin is a thermosetting resin, for example a melamine based resin, such as a melamine formaldehyde resin, wherein this resin is preferably free of said hard particles.

This stack 2 is preferably formed in the pressing device. The pressing device comprises two metal press plates 7a, 7b which are arranged movable towards each other, such as to press the stack 2 which is formed between said press plates 7a, 7b. The press plates 7a, 7b are heatable, such that not only pressure is generated with said press plates 7a, 7b but also heat is conducted to said stack 2. With the aid of the pressing device the stack 2 is pressed and heated, as such to form a pressed stack 1, with the base top layer 4, the board 3 and the base balancing layer 5 interconnected to each other. FIG. 2 shows such a pressed stack 1.

The press plates 7a, 7b comprise a first press plate 7a and a second press plate 7b. These press plates 7a, 7b can be one piece press plates, however the first and/or the second press plate 7a, 7b can comprise two or more smaller plates which together form said press plate 7a, 7b. The pressing device is for example a single daylight press. The first press plate 7a contacts the base top layer 4 and the second press plate 7b contacts the base balancing layer 5.

The first press plate 7a comprises a contact surface which is provided to contact the base top layer 4. This contact surface forms, as can be seen in FIG. 1, the bottom of the first press plate 7a. This contact surface can or cannot be a structured surface. For example it can be desirable that the base top layer 4 of the pressed stack 1 comprises a certain structure, for example a wood structure or stone structure and/or a structure with bevels/chamfers. By pressing a structure in the base top layer 4 with the aid of said first press plate 7a, wood or stone can be better imitated and/or bevels can be present in the floor panels 10. The pressing of said structure can be or cannot be in register.

The second press plate 7b comprises an upper surface which faces and contacts the base balancing layer 5, wherein said upper surface comprises a structure, said structure having a base surface 8 and indentations 9 which form lower areas 11 relative to said base surface 8. Said base surface 8 extends according to a first plane, the indentations 9 all have the same shape and dimensions, and the lower areas 11 are flat surfaces which all extend in a second plane, said first plane and second plane are parallel to each other and the height difference D between said lower areas 11 and the base surface 8, thus between said first and second plane is at least 100 μm, and preferably is located between 180 μm and 220 μm. These lower areas 11 are flat surfaces and several possibilities for the shape of said lower areas 11 are possible. For example the shape can be chosen from the list: hexagons, octagons, circles, triangles and squares. The base surface 8 forms partitions between said lower areas 11 and preferably said base surface 8 forms one continuous whole which separates said lower areas 11 at equal distances, as such forming a pattern. For example, a said lower area 11 can have a first circumscribed circle, said partitions of the base surface 8 at the height of the lower area 11 can have a second circumscribed circle with the same center as the first circumscribed circle, wherein the ratio of the radius of the first circumscribed circle upon the radius of the second circumscribed circle is between ⅓ and ⅚, for example ⅔. FIG. 3a is an example of a bigger ratio in comparison with FIG. 3b. In the FIGS. 3a, 3b and 4a to 4d, distances between two indentations 9 is indicated with A and dimensions of the lower areas 11 are indicated with B. As can be seen, the dimension B is normally larger than the dimension A. The lower areas 11 are separated from the base surface 8 by slopes 13, these slopes 13 preferably make an angle a with the lower area 11 of between 91° and 100°, such that the second press plate 7b can loosen easily after the pressing. Since the slopes 13 are close to 90°, the top views can be as indicated in FIGS. 3a, 3b and FIGS. 4a to 4d.

The pressed stack 1 has protrusions 90 which match the indentations 9. As can be seen in FIG. 6, the base balancing layer 5 of the pressed stack 1 is typically a resin impregnated paper, wherein the paper is impregnated with resin and a surplus of resin is present at both sides of the paper. Because said indentations 9 have a limited thickness dimension, the paper is not embossed after the pressing, only the lowermost resin 12 of the base balancing layer 5 present beneath the paper is embossed and comprises said protrusions 90. The base balancing layer 5 comprises a base bottom surface 80, and protrusions 90 with flat top planes 110, wherein said top planes 110 are connected to said base bottom surface 80 by slopes 130, said slopes 130 making an angle with the top planes 110 of between 91° and 100°. The height difference (d) between the base bottom surface 80 and the top planes 110 is preferably located between 190 μm and 210 μm.

Preferably further processing steps are applied upon this pressed stack 1 to form said floor panels 10. Typically the pressed stack 1 is divided into smaller panels, for example by cutting and/or sawing. These smaller panels are then subjected to further processing steps, such as milling coupling parts 14a, 14b (for example milling a male tongue 14b and a female groove 14a) and/or applying coatings, for example water repellent coatings and/or applying lacquers and/or applying impregnations agents and/or shaping bevels, as such to obtain panels 10 with the desired characteristics. Important here is that said protrusions 90, because of their limited dimensions, do not negatively influence said further processing steps. The floor panel 10 comprises a top layer 40 derived from the base top layer 4, a substrate 30 derived from the board 3 and a balancing layer 50 derived from the base balancing layer 5. The second press plate 7b can be configured in such a way that said protrusions 90 are or are not present at the height of coupling parts 14a, 14b. This is shown in FIGS. 9a and 9b, wherein in FIG. 9a, said protrusions 90 are present at the height of the entire bottom of the panels 10. In FIG. 9b, said protrusions 90 are not present at the height of a lower lip of the female coupling part 14a. In FIG. 9b it is clearly shown that said protrusions 90 create an increase in height for the laminate panel 10.

The second embodiment of the method to produce the laminate floor panel 10 as shown in FIG. 10, comprises many similarities with the first embodiment, with the difference that instead of two press plates 7a, 7b, two calendaring rolls 7a, 7b are used. Such a configuration is useful when there is a continuous production. This second embodiment can for example be used to make SPC panels, more specifically melamine SPC panels, since melamine SPC floor panels typically have a thermoplastic based core 30, one or more melamine based resin impregnated papers which form the top layer 40 and a melamine based resin impregnated paper which forms the base layer 50. Also for the first deviating variant of the first and second aspect of the invention, where the floor panel does not comprise a balancing layer, this second embodiment is useful.

The present invention is by no means limited to the above-described embodiments, but can be realized according to various variants without departing from the scope of the invention.

1.-34. (canceled).

35. A method to produce a laminate panel, for example a laminate floor panel, comprising the steps of:
forming a stack comprising a board, a base top layer and a base balancing layer,
wherein said board is located between said base top layer and said base balancing layer,
wherein said board is a lignocellulose-based board such as a wood fiber board or a particle board, and
wherein said base top layer comprises synthetic material and said base balancing layer comprises synthetic material;
pressing the stack using a pressing device, said pressing device comprising at least a first press element and at least a second press element,
wherein the stack is pressed between said first and second press element in such a way that the first press element contacts the base top layer, the second press element contacts the base balancing layer, the base top layer adheres to the board, the base balancing layer adheres to the board and a pressed stack with the base top layer, the board and the base balancing layer interconnected, is formed;
wherein the second press element comprises an upper surface which faces and contacts the base balancing layer,
wherein said upper surface comprises a structure, said structure having a base surface and indentations which form lower areas relative to said base surface,
wherein maximum height differences between said lower areas and the base surface are located between 100 μm and 350 μm.

36. The method according to claim 35, wherein the indentations are individual indentations separated by said base surface, said base surface forming partitions between said indentations,
wherein said partitions substantially form a continuous whole.

37. The method according to claim 36, wherein the indentations are separated from each other at equal distances from each other.

38. The method according to claim 37, wherein maximum distances between consecutive indentations are located between 0.5 mm and 3 mm.

39. The method according to claim 36, wherein the indentations have the same shape and dimensions.

40. The method according to claim 35, wherein the indentations have curved or flat slopes which separate the lower areas from the base surface, said slopes having an inclination with the lower areas situated between 90° and 135°.

41. The method according to claim 36, wherein, seen according to the plane of the second press element, the lower areas have a first circumscribed circle and the corresponding surrounding partitions of the base surface have a second circumscribed circle with the same center as the first circumscribed circle,
wherein the ratio of the radius of the first circumscribed circle upon the radius of the second circumscribed circle, is located between 0.5 and 0.9.

42. The method according to claim 35, wherein the lower areas are hexagon or octagon shaped.

43. The method according to claim 35, wherein the thickness of the pressed stack is at most 0.3 mm thinner than the thickness of the stack before the pressing.

44. The method according to claim 35, wherein a said synthetic material of the base top layer and the base balancing layer is a thermosetting resin.

45. The method according to claim 44, wherein the base top layer comprises a first thermosetting resin and the base balancing layer comprise a second thermosetting resin,
wherein said second thermosetting resin is less reactive than said first thermosetting resin.

46. A laminate panel, comprising, seen from the top to the bottom, a top layer comprising synthetic material, a substrate, being a lignocellulose based substrate, and a balancing layer comprising synthetic material,
wherein the balancing layer comprises an outer surface opposite said substrate, said outer surface comprising a structure having a base bottom surface and individual protrusions which protrude with regard to said base bottom surface,
wherein maximum differences in height between said base bottom surface and said protrusions are located between 100 μm and 350 μm.

47. The laminate panel of claim 46, wherein the base bottom surface extends in a first plane which is according to the plane of the laminate panel,
wherein said base bottom surface forms partitions between said protrusions,
wherein said partitions substantially form a continuous whole.

48. The laminate panel according to claim 46, wherein the protrusions are separated from each other at equal distances from each other.

49. The laminate panel according to claim 48, wherein maximum distances between consecutive protrusions are located between 0.5 mm and 3 mm.

50. The laminate panel according to claim 46, wherein the protrusions each comprise a top plane,
wherein the top planes all extend in a plane and define said maximum differences in height,
wherein the top planes of the protrusions are separated from the base bottom surface by curved or flat slopes, said slopes having an inclination with the base bottom surface situated between 90° and 135°.

51. The laminate panel according to claim 50, wherein the top planes are hexagon or octagon shaped.

52. The laminate panel according to claim 46, wherein the protrusions have the same shape and dimensions.

53. The laminate panel according to claim 46, wherein the substrate is a lignocellulose-based board, for example a wood fiber board, having an average density of at least 600 kg/m³ and/or of at most 1000 kg/m³.

54. The laminate panel according to claim 46, wherein a said synthetic material of the top layer and the balancing layer is a thermosetting resin,
wherein the top layer comprises a first thermosetting resin and the balancing layer comprises a second thermosetting resin,
wherein said first thermosetting resin differs from said second thermosetting resin.
